(19) United States
(12) Patent Application Publication
(10) Pub. No.: US 2011/0294473 A1
(43) Pub. Date: Dec. 1, 2011

(54) METHOD AND SYSTEM FOR OBTAINING AUTOGRAPHED PHOTOGRAPH VIA A MOBILE COMMUNICATION NETWORK

(75) Inventor: Pandiarajan Subburam, Kovilpatti (IN)

(73) Assignee: NEXMOO SOLUTIONS (INDIA) PRIVATE LIMITED, Chennai, Tamil Nadu (IN)

(21) Appl. No.: 12/992,304

(22) PCT Filed: May 15, 2009
(86) PCT No.: PCT/IN2009/000290

§ 371 Date: Jun. 6, 2011

Related U.S. Application Data
(60) Provisional application No. 61/053,376, filed on May 15, 2008.

(51) Int. Cl. H04W 4/00

(52) U.S. Cl. 455/414.1

(57) ABSTRACT

The invention provides a method and system for obtaining an autographed photograph via a mobile communication network. The user accesses the platform offering the services required for obtaining the autographed photograph via a mobile communication network. Upon access, the user indicates the choice of the background upon which the autograph of the celebrity is to appear. Thereafter, the user enters the customized text as required by the user to appear on the background. The text information submitted by the user is converted into the font corresponding to the handwriting font of the chosen celebrity. The converted information is displayed on the chosen back ground with the autograph. A preview of the final autographed photograph is displayed to the user. If the preview is satisfactory to the user, the user sends the contact details to which the autographed photograph is to be sent.

### FIELD OF THE INVENTION

The invention relates to obtaining the autograph of a celebrity more particularly, a method and system for obtaining the autograph of a celebrity by employing a mobile communication network without the requirement for either the celebrity or the user who is a fan of the celebrity, to be present at the same place and also, at any time, in accordance with the requirements and convenience of the fan.

### BACKGROUND OF THE INVENTION

Even before the advent of the industrial age, people were engaged in participating and watching activities such as sports, theatrics and the like. As a result of their exemplary performance in the sports or theatrics, some of the participants acquired a celebrity status.

The people involved in watching the activities, whether the activity is theatrics or the activity is sports, are generally interested in the information pertaining to the celebrities involved. In addition, the people involved in watching the performance may be interested in obtaining the signature of the celebrity as a matter of memory pertaining to the event and also as a matter of creating a collection pertaining to the concerned celebrity.

With the advent of the industrial age, technology has invaded all spheres of life including sports and mass entertainment, such as sports, theatrics, cinema. As a result of invasion of technology, the range of the people participating and watching the activities has increased. Prior to the invasion of technology, the range of the people participating and the people watching the activities was restricted to a limited territory such as, a village.

However, with the advent of industrial era, in view of the technological facilities available, it is but natural that the range of the people watching the activity and people participating in the activity has increased.

As a result, the happenings of the sports, theatrics and other mass entertainment activities, are broadcast globally. Due to the global broadcast, it may not be possible that the fans are in the actual physical proximity of the celebrity.

Prior to the advent of the industrial era, the range of the people participating and the people watching the activities was restricted to a limited territory. As a result, it was possible for the fans to obtain the signature of the celebrity. Presently, in the modern scenario, the fans that are not in the physical proximity may also require the autograph of the celebrity. In addition, even if the autograph is obtained at a live event, problems faced are, the process of obtaining the autograph is not convenient from the user point of view.

A few disclosures are available in the art, in which, it is possible to obtain the autograph of the celebrity even if the fan and the celebrity are not in proximity.

For example, a disclosure describes the method of obtaining the autograph of the celebrity from a remote location. The user provides the celebrity with a message with which the user desires the celebrity to personalize the selected photographic image. The user types the desired message at an appropriate location on a menu. In other embodiments, the user can provide an audio file containing a verbal request for the desired message. The message can include one or more words, numerals, symbols or other images, and can be in any desired language and/or alphabet. In other specific embodiments, the user can select a message from a menu of standard messages.

Once the desired message has been prepared, it is then transmitted to the site at which the celebrity is present. In particular preferred embodiments, at this point an arrangement is made by which the user provides a payment to the celebrity for the personalized photographic image. Any desired means for arranging such payment can be employed, for example, use of a credit card by the user. However, in this disclosure, the user has to obtain the signature of the celebrity by transmission to the site at which the celebrity is present which is cumbersome.

Another disclosure is revealed in which, a method of producing a photograph of a celebrity figure with personalized and autographed messages is disclosed. However, in this disclosure, the user has to have access to Internet and has to necessarily have access to a communication terminal, which is Internet-enabled and discloses the procedure primarily deployable on a computer terminal.

Certain other disclosures are available in the art, which reveal a method and system in which the autograph is obtainable at a remote location.

Proposals in the art, however do not reveal a simply implemented method and system, in which, the autograph of a celebrity can be obtained, in which the user is at a location remote from the celebrity.

Proposals in the art, do not reveal a simply implemented method and system, in which, the autograph of a celebrity can be obtained at a time, in accordance with the convenience of the user.

Proposals in the art, do not reveal a simply implemented method and system, in which, the autograph of a celebrity can be obtained at a location, in accordance with the convenience of the user.

Proposals in the art do not reveal a simply implemented method and system, in which, the autograph of a celebrity can be obtained at a remote location, in which, it is not mandatory to have Internet access.

Proposals in the art, do not reveal a simply implemented method and system, in which, the autograph of a celebrity can be obtained, in which the celebrity is not required to be present, even at a location remote from the user.

Proposals in the art, do not reveal a simply implemented method and system, in which, the autograph of a celebrity can be obtained, containing text input by the user, at any location at which the user is present.

There is therefore, a need for a method and system in which, the autograph of a celebrity can be obtained, in which the user is at a location remote from the celebrity.

Further, there is a need for a method and system in which the autograph of a celebrity can be obtained at a time, in accordance with the convenience of the user.

Still further, there is a need for a simply implemented method and system, in which, the autograph of a celebrity can be obtained at a location, in accordance with the convenience of the user.

Further more, there is a need for a simply implemented method and system, in which, the autograph of a celebrity can be obtained at a remote location, in which, it is not mandatory to have Internet access.

There is also, a need for a simply implemented method and system, in which, the autograph of a celebrity can be obtained, in which the celebrity is not required to be present, even at a location remote from the user.

Further more, there is a need for a simply implemented method and system, in which, the autograph of a celebrity can be obtained, containing text input by the user, at any location at which the user is present.

### SUMMARY

Accordingly the first aspect of the invention is a method and system, in which, the autograph of a celebrity is obtained, in which the user is at a location remote from the celebrity.

Another aspect of the invention is, a method and system, in which, the autograph of a celebrity can be obtained at a time, in accordance with the convenience of the user.

Yet another aspect of the invention is, a method and system, in which, the autograph of a celebrity can be obtained at a location, in accordance with the convenience of the user.

Still another aspect of the invention is, a method and system, in which, the autograph of a celebrity can be obtained at a remote location, in which, it is not mandatory to have Internet access.

Further still another aspect of the invention is, a method and system, in which, the autograph of a celebrity can be obtained, in which the celebrity is not required to be present, even at a location remote from the user.

Further still another aspect of the invention is, a method and system, in which, the autograph of a celebrity can be obtained, containing text input by the user, at any location at which the user is present.

Another aspect of the present invention is to provide a method and system for obtaining an autographed photograph via a mobile communication network. The said method involves the user accessing the platform offering the services required for obtaining the autographed photograph via a mobile communication network. Upon access, the user indicates the choice of the background upon which the autograph of the celebrity is to appear. Thereafter, the user enters the customized text as required by the user to appear on the background. The text information submitted by the user is converted into the font corresponding to the handwriting font of the chosen celebrity. The converted information is displayed on the chosen back ground with the autograph. A preview of the final autographed photograph is displayed to the user. If the preview is satisfactory to the user, the user sends the contact details to which the autographed photograph is to be sent. It will be apparent to a person skilled in the art that even though such services are provided with financial arrangement between the entities involved, revenue sharing may exist between the celebrity, platform provider and the supporting entities, the present invention may also be deployed without any such sharing of revenue. It may also be conducted without sharing of revenue or may be conducted by sharing of revenue in alternative forms.

### BRIEF DESCRIPTION OF DRAWINGS

The detailed description in conjunction with the accompanying drawings provides a clear understanding of the invention.

Persons skilled in the art will appreciate that variations and combinations of the concept and components of the invention disclosed herein, are also to be treated as a part of the present disclosure.

FIG. 1 is a flow chart of a method of obtaining an autograph via a mobile communication device, in accordance with one embodiment of the present invention.

FIG. 2 is a flow chart of a method of obtaining an autograph via a mobile communication device in accordance with another embodiment of the invention.

FIG. 3 is a system diagram illustrating the components constituting the system for obtaining an autograph provided with a screen size detection component.

### DETAILED DESCRIPTION OF DRAWINGS

Since time immemorial, fans of celebrities have been intent on obtaining memorabilia concerning the celebrity. If the memorabilia is an autograph of the celebrity embedded on the photograph of the celebrity, the value of the memorabilia is increased by several times. The present invention is concerned with obtaining such an autographed photograph of a celebrity via a mobile communication network.

Although the present disclosure describes the implementation of the invention with reference to a celebrity and the associated fan, it is very apparent to a person skilled in the art that the present disclosure is not restricted to only such a circumstance and it is also effectively deployable between two individuals, entities intending to obtain a memorabilia. The advantage of the present invention lies in the fact that the autographed memorabilia is obtainable in a location and time of the user's convenience.

In an embodiment, the present invention discloses a method for obtaining autographed photograph via a mobile communication network. The method involves accessing by a user of the platform offering the services required for obtaining the autographed photograph via a device operable on a mobile communication network. Then, accepting an input of the user, contact is established between the user and the platform offering the services. Subsequently, the user selects the chosen background, in which the autograph of the celebrity is to be displayed. The said background is chosen from among a set of photographs stored in a database containing photographs of celebrities.

The handwritten message is displayed on the photograph based on the user requirement. The handwriting font of the message is digitized version of hand-written fonts corresponding to the celebrity.

The integrated file generated in accordance with input or indication of user from a database is retrieved and a preview of retrieved output is generated.

The selected celebrity photograph with the hand written message of the said celebrity is delivered to the mobile communication device of the user after the said user accept the preview.

In an embodiment, the user criterion for location is a location remote from the location of celebrity in accordance with user convenience.

In an embodiment, the user criterion for time is a time in accordance with user convenience.

The user inputs content to be displayed on the final output. It is apparent to a person skilled in the art that, even though mode of input as depicted predominantly in the present disclosure is via text input through a device operable on a mobile communication network, however, the modes of user input may be via other modes of input alternatively known in the art. The other modes of input are inclusive but not restricted to voice inputs.

In an embodiment, the user indicates content to be displayed from among a plurality of content.

In an embodiment, the step of delivering the final output to the user involves determining if the system requirements of device enable accommodating the substantially complete material.

In an embodiment, the step of delivering the final output to the user involves determining if the screen size of the device is capable of accommodating the substantially complete material to be displayed.

In an embodiment the present invention discloses a system comprising a user access module to enable obtaining the autographed photograph via a device operable on a mobile communication network. The user access module enables obtaining of autographed photograph at a location and time governed by user criterion.

The present invention further comprises a module to enable accepting an input of the user, and a contact is established between the user and the platform offering the services, after which the user selects the chosen background, in which the autograph of the celebrity is to be displayed. The background is chosen from among a set of photographs stored in a database containing photographs of celebrities.

The present invention further comprises a module for displaying handwritten message on the photograph based on the user requirement wherein the hand-writing font of the message is digitized version of hand-written fonts corresponding to the celebrity.

The present invention further comprises a module to retrieve integrated file from a storage means, the said file generated in accordance with input or indication of user and producing a preview of retrieved output.

The present invention further comprises a module to deliver the selected celebrity photograph with the hand written message of the said celebrity to the mobile communication device of the user after the said user accept the preview.

The system for obtaining autographed photograph via a mobile communication network further comprises storage means which comprises of data associated with user.

The system for obtaining autographed photograph via a mobile communication network further comprises the storage means which comprises a database.

The system for obtaining autographed photograph via a mobile communication network further comprises the database which comprises images.

The system for obtaining autographed photograph via a mobile communication network further comprises means to convert the message of the user required to be displayed is digitized version of hand-written fonts corresponding to the celebrity.

The system for obtaining autographed photograph via a mobile communication network comprises the database, which comprises samples of handwriting font.

The system for obtaining autographed photograph via a mobile communication network comprises samples of handwriting font of a plurality of celebrities.

The system comprising means for electronic data input, means for storing and module for retrieving the photograph and text in the electrical communication with the autograph management server having interface. The said server is connected to the mobile switching center through Internet protocol connection wherein the said mobile switching center is connected to base transceiver station through base station controller.

It is an embodiment of the present invention, a system for providing a autograph of the celebrity to subscriber of a wireless mobile communications service targeted to the subscriber on the basis of network of the mobile service comprising means to store the plurality of photographs of the celebrities and means to have the database of the handwritten text of the celebrities to be provided to the subscriber. The mobile handset is capable of initiating and receiving a call signal. The user access the photographs stored in the storing means of photograph management server and select the photograph of the celebrity. The user optionally enters or selects the text to be displayed on the photograph of the said celebrity or the system automatically provides a text. The selected photograph with the text entered is appeared in the display of the mobile hand set on selecting the preview option. The text appeared on the display of the said mobile handset is the handwritten text of the selected celebrity, which is equivalent to the text entered by the user. The selected photograph is sent to the user upon request via communication network.

Autograph management system comprising the server provided with interface, means to store the photographs of the celebrities and the hand written text of the celebrity such as electronic data, text, symbol, special characters, images, alpha numeric or combination thereof.

The interface integrate with the server, means to store photographs of the celebrities and the hand written text of the celebrity such as electronic data, text, symbol, special characters, images, alpha numeric or combination thereof. The server is connected with any other local server and/or remote server through the communication network to provide this service.

The system is associated with the base station controller through mobile switching center, which is connected with the base transceiver station and in communication with the autograph management system and a Local Landline Network wherein the base station controller controls two or more base transceiver stations as the subscriber moves from an area serviced by one base transceiver station to an area serviced by another base transceiver station. The said server of the autograph management system operates in the same manner to provide the autographs of the celebrity to the subscriber on the basis of the GSM service area/PLMN service area/MSC service area/location area/cell area served by BTS.

User is the subscriber of the service provider in the communication network. The platform provider is the service provider of the mobile service in the communication network.

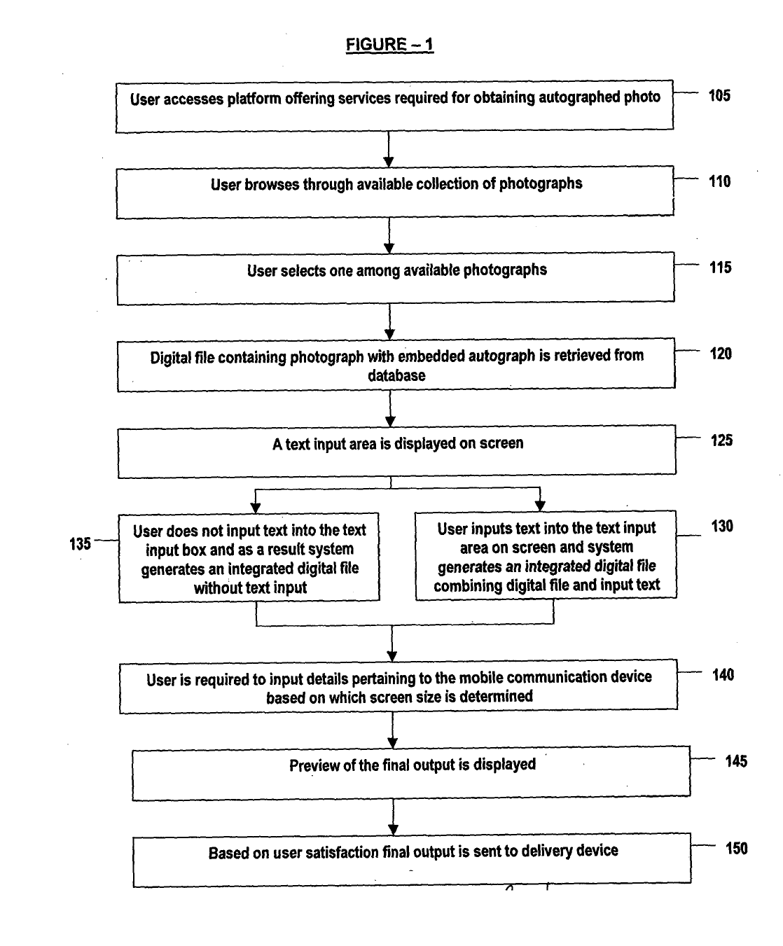

FIG. 1 is a flow chart of a method of obtaining an autograph, in accordance with the present invention.

At step 105, the user accesses the platform offering the services required for obtaining the autographed photograph via a mobile communication network. In an embodiment, the device operating on the mobile communication network is a mobile phone. In other embodiments, the user establishes contact with the platform offering services via other devices operating on the mobile communication network may be a pager or any other similar device, which is capable of operating on a mobile communication network.

It would be apparent to a person skilled in the art, that the device for accessing the platform offering the services is not restricted to a device operating on the mobile communication network However, the device on which the final output is obtained is a device operating on the mobile communication network.

In addition, in an embodiment, the connection established between the user and the platform offering the services is via wireless application protocol (WAP). In another embodiment, the connection established between the user and the platform offering the services is via General Packet Radio Service (GPRS). In yet another embodiment, the connection established between the user and platform offering the services is via short message service (SMS). It will be apparent to a person skilled in the art, that the modes of establishing contact with the platform offering services is disclosed for the purpose of illustration only. It will be readily apparent to person skilled in the art, that the alternative modes of establishing contact namely, Bluetooth, Wifi, Wimax and the like are also within the scope and ambit of the present disclosure.

At step 110, the user browses through available collection of photographs of the celebrity. A set of photographs is stored corresponding to each celebrity.

At step 115, the user selects one among the available photographs. The selected photograph is the choice of the background upon which the autograph of the celebrity appears. The present invention is disclosed with the background of the photograph of the celebrity. It will be readily apparent to a person skilled in the art, that the present invention is deployable without the background of the celebrity's photograph. It will also readily apparent to a person skilled in the art, that the background embodied as the photograph of the celebrity has been disclosed as stationary. However, in an alternative embodiment, the background may be an animated background also. It would be apparent to a person skilled in the art that any variations or combinations in the components constituting the background would fall within the scope and ambit of the present disclosure.

At step 120, in accordance with the choice of the user, the digital file corresponding to the background containing photograph of celebrity with the embedded autograph is retrieved from the database containing the photographs of the various celebrities.

At step 125, a text input area is displayed on the screen, in which the user can input text, which is subsequently displayed on the final output along with the autograph on the chosen background. The modes of user input may be via other modes of input alternatively known in the art. The other modes of input are inclusive but not restricted to voice inputs. The content of the input may be inclusive but not restricted to alpha-numeric data.

At step 130, if the user inputs text into the text input area displayed on the screen, the system generates an integrated digital file combining both the digital file containing the autograph on the photograph of the celebrity and also the text input by the user. In an embodiment, the handwriting font is that of the celebrity.

However, it is apparent to a person skilled in the art, that hand writing font may belong to the user. In embodiments, it is also possible that the handwriting font may belong to common font, which is neutral and does not belong to either the celebrity or the user. It would also be apparent to a person skilled in the art, that language in which the user inputs the message is not restricted to one. The autograph may be in one language and the user input text may be in a different language.

At step 135, if the user decides not to input any message, the system generates an integrated digital file containing the autograph on the photograph of the celebrity.

At step 140, the user is required to input the details pertaining to the mobile communication device to which the autographed photograph is to be sent. In an embodiment the details may be the model of the mobile communication device. Based on the details entered, the system determines the screen size of the mobile communication device to which the autographed photograph is to be sent.

At step 145, the preview of the final output as viewable at the delivery device is displayed. If the preview is satisfactory to the user, the user sends the contact details of the mobile communication device to which the autographed photograph is to be sent.

At step 150, the final output displaying the autographed photograph is sent to the delivery device.

It will be apparent to a person skilled in the art that even though such services are provided with financial arrangement between the entities involved, revenue sharing may exist between the celebrity, platform provider and the supporting entities, the present invention may also be deployed without any such sharing of revenue. It may also be conducted without sharing of revenue or may be conducted by sharing of revenue in alternative forms.

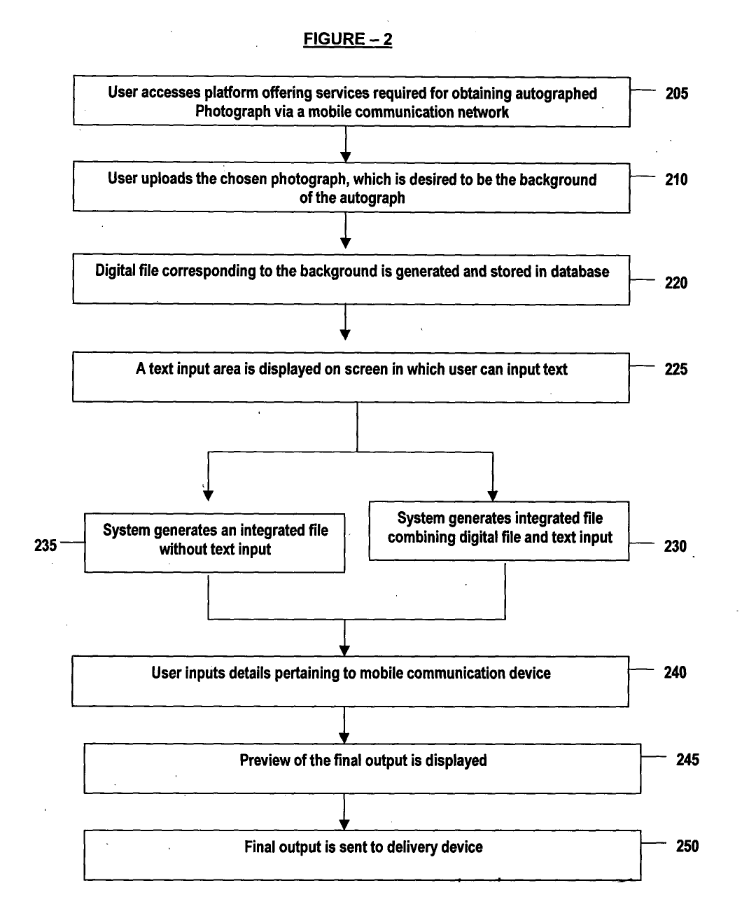

FIG. 2 is a flow chart of a method of obtaining an autograph via a mobile communication device in accordance with another embodiment of the invention.

At step 205, the user accesses the platform offering the services required for obtaining the autographed photograph via a mobile communication network.

In an embodiment, the device operating on the mobile communication network is a mobile phone. In other embodiments, the user establishes contact with the platform offering services via other devices operating on the mobile communication network may be a pager or any other similar device, which is capable of operating on a mobile communication network.

At step 210, the user uploads the chosen photograph, which is desired to be the background of the autograph. In an embodiment, the photograph may be the user's photograph.

At step 220, in accordance with the choice of the user, the digital file corresponding to the background is generated and stored in the database containing the photographs of the various celebrities.

At step 225, a text input area is displayed on the screen, in which the user can input text, which is subsequently displayed on the final output along with the autograph on the chosen background.

At step 230, if the user inputs text into the text input area displayed on the screen, the system generates an integrated digital file combining both the digital file containing the autograph on the background and also the text input by the user. In an embodiment, the handwriting font is that of the celebrity.

However, it is apparent to a person skilled in the art, that hand writing font may belong to the user. In embodiments, it is also possible that the handwriting font may belong to common font, which is neutral and does not belong to either the celebrity or the user. It would also be apparent to a person skilled in the art, that language in which the user inputs the message is not restricted to one. The autograph may be in one language and the user input text may be in a different language.

At step 235, if the user decides not to input any message, the system generates an integrated digital file containing the autograph on the chosen photograph. It will be apparent to a person skilled in the art that the invention may be deployed without the option of entry of a message by the user.

At step 240, the user is required to input the details pertaining to the mobile communication device to which the autographed photograph is to be sent. In an embodiment the details may be the model of the mobile communication device. Based on the details entered, the system determines the screen size of the mobile communication device to which the autographed photograph is to be sent.

At step 245, the preview of the final output as viewable at the delivery device is displayed. If the preview is satisfactory to the user, the user sends the contact details of the mobile communication device to which the autographed photograph is to be sent.

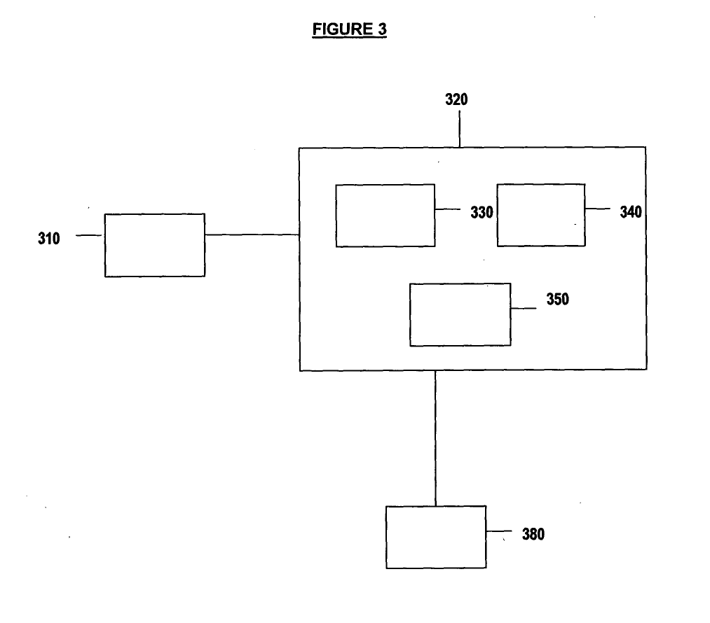

At step 250, the final output displaying the autographed photograph is sent to the delivery device. The method deployed in the invention is achieved by a system explained in detail in conjunction with FIG. 3.

FIG. 3 is a system diagram illustrating the components constituting the system for obtaining an autograph and provided with a screen size detection component.

The present invention is concerned with obtaining such an autographed photograph of a celebrity via a mobile communication network. The invention is deployed in conjunction with a user input device 310. The user input device, is a device operating on the mobile communication network and is a mobile phone in an embodiment. In other embodiments, the user establishes contact with the platform offering services pertaining to photograph with embedded autograph via other devices operating on the mobile communication network. Such devices may be a pager or any other similar device, which is capable of operating on a mobile communication network.

It would be apparent to a person skilled in the art, that the device for accessing the platform offering the services 320 is not restricted to a device operating on the mobile communication network However, the device on which the final output 380 is obtained is a device operating on the mobile communication network.

The user input is accepted via the mobile communication network. Using the input of the user, contact is established between the user and the platform offering the services. The user selects the chosen background, in which, the autograph of the celebrity is to be displayed. The background is chosen from among a set of photographs stored in a database 330 containing photographs of celebrities. It has to be noted that, in an embodiment, the photograph may be the user's photograph.

The photograph is embedded with the autograph, if the background is the photograph of the celebrity. In the case, the photograph is the photograph of the user; the autograph is integrated with the photograph subsequently.

Based on user requirement, the user may attach a message to the photograph. The handwriting font of the message may be that of the celebrity. The handwriting font is generated from digitized version of hand-written fonts corresponding to the celebrity. The digitized version of the handwritten fonts is pre-stored in database 340.

In alternative embodiments, the handwriting font may be that of the user. In yet another embodiment, it is also possible that the hand written font may belong to common font, which is neutral and does not belong to either the celebrity or the user.

It may be readily apparent to a person skilled in the art that database 330 and database 340 may be integrated or exist as separate entities. If the user decides not to input any message, the system generates an integrated digital file containing the autograph on the chosen photograph. It will be apparent to a person skilled in the art, that the invention may be deployed without the option of entry of a message by the user.

The user inputs the details pertaining to the mobile communication device to which the autographed photograph is to be sent. In an embodiment, the details may be the model of the mobile communication device. Based on the details entered, the system determines the screen size of the mobile communication device to which the autographed photograph is to be sent by employing a screen size determination component 350. The screen size determination component may be a component existing on the services offering platform.

The preview of the final output as viewable at the delivery device is displayed. If the preview is satisfactory to the user, the user sends the contact details of the mobile communication device to which the autographed photograph is to be sent.

The present invention, in addition to obtaining the autograph on photograph, enables collection of fan details. As a result, the present invention may enable targeted advertisement. In an embodiment, in any event that involves the presence of the celebrity, the collection of fan details may be targeted for advertisement.

In another embodiment, the autograph photograph may be dedicated to a predetermined mobile number other then the device associated with the user.

In yet another embodiment, the autograph photograph may be conveyed to the user or any other suggested number on a predetermined day. It will be apparent to a person skilled in the art that the advantages and any secondary advantages arising out of the primary advantages fall within the scope and ambit of the present disclosure.

1. A method for obtaining autographed photograph via a mobile communication network, said method comprising the steps of:
(a) accessing the platform offering the autographed photograph via a device operable on a mobile communication network by a user;
(b) accepting an input of the user, contact is established between the user and the platform offering the services; the user selects the chosen background, in which the autograph of the celebrity is to be displayed; wherein the background is chosen from among a set of photographs stored in a database containing photographs of celebrities;
(c) displaying handwritten message on the photograph based on the user requirement wherein the hand writing font of the message is digitized version of hand-written fonts corresponding to the celebrity;
(d) retrieving integrated file generated in accordance with input or indication of user from a database and producing a preview of retrieved output;
(e) delivering the selected celebrity photograph with the hand written message of the said celebrity to the mobile communication device of the user after the said user accept the preview.

2. The method for obtaining autographed photograph via a mobile communication network as claimed in claim 1, wherein, the user criterion for location is a location remote from the location of celebrity in accordance with user convenience.

3. The method for obtaining autographed photograph via a mobile communication network as claimed in claim 1, wherein, the user criterion for time is a time in accordance with user convenience.

4. The method for obtaining an autographed photograph via a mobile communication network as claimed in claim 1, wherein the user inputs content to be displayed on the final output.

5. The method for obtaining autographed photograph via a mobile communication network as claimed in claim 1, wherein the user indicates content to be displayed from among a plurality of content.

6. The method for obtaining autographed photograph via a mobile communication network as claimed in claim 1, wherein, the step of delivering the final output to the user involves determining if the system requirements of device enable accommodating the substantially complete material.

7. The method for obtaining autographed photograph via a mobile communication network as claimed in claim 6, wherein, the step of delivering the final output to the user involves determining if the screen size of the device is capable of accommodating the substantially complete material to be displayed.

8. A system for obtaining autographed photograph via a mobile communication network, said system comprising the following components:
(a) user access module to enable obtaining the autographed photograph via a device operable on a mobile communication network, wherein, the user access module enables obtaining of autographed photograph at a location and time governed by user criterion;
(b) module to enable accepting an input of the user, contact is established between the user and the platform offering the services; the user selects the chosen background, in which the autograph of the celebrity is to be displayed; wherein the background is chosen from among a set of photographs stored in a database containing photographs of celebrities;
(c) module for displaying handwritten message on the photograph based on the user requirement wherein the hand writing font of the message is digitized version of hand-written fonts corresponding to the celebrity;
(d) module to retrieve integrated file from a storage means, the said file generated in accordance with input or indication of user and producing a preview of retrieved output;
(e) module to deliver the selected celebrity photograph with the hand written message of the said celebrity to the mobile communication device of the user after the said user accept the preview.

9. The system for obtaining autographed photograph via a mobile communication network as claimed in claim 8, wherein the storage means comprises of data associated with user.

10. The system for obtaining autographed photograph via a mobile communication network as claimed in claim 8, wherein the storage means comprises a database.

11. The system for obtaining autographed photograph via a mobile communication network as claimed in claim 10, wherein the database comprises images.

12. The system for obtaining autographed photograph via a mobile communication network as claimed in claim 1, wherein means to convert the message of the user required to be displayed is digitized version of hand-written fonts corresponding to the celebrity.

13. The system for obtaining autographed photograph via a mobile communication network as claimed in claim 10, wherein the database comprises samples of handwriting font.

14. The system for obtaining autographed photograph via a mobile communication network as claimed in claim 13, wherein the sample comprises samples of handwriting font of a plurality of celebrities.
